(19) United States
(12) Patent Application Publication
(10) Pub. No.: US 2026/0188583 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Ji Hun LEE, Suwon-si (KR); Tae Yong KIM, Suwon-si (KR)

(73) Assignee: SAMSUNG ELECTRO-MECHANICS CO., LTD., Suwon-si (KR)

(21) Appl. No.: 19/338,153

(22) Filed: Sep. 24, 2025

(30) Foreign Application Priority Data
Dec. 26, 2024 (KR) 10-2024-0197576

(51) Int. Cl. H01G 4/232; H01G 4/008; H01G 4/012; H01G 4/12; H01G 4/30

(52) U.S. Cl. CPC H01G 4/232; H01G 4/008; H01G 4/012; H01G 4/12; H01G 4/30

(57) ABSTRACT

A multilayer electronic component includes a body having a dielectric layer, a first internal electrode, and a second internal electrode alternately stacked in a first direction with the dielectric layer interposed therebetween. The body defines opposing first and second surfaces in the first direction, opposing third and fourth surfaces in a second direction, and opposing fifth and sixth surfaces in a third direction. A first dummy electrode is spaced from the first internal electrode and connected to the fifth or sixth surface, and a second dummy electrode is spaced from the second internal electrode and connected to the third or fourth surface. The first and second internal electrodes include overlapping main portions with concave portions centered in the second direction to alleviate step portions and improve reliability.

### CROSS-REFERENCE TO RELATED APPLICATION(S)

This application claims the benefit of priority to Korean Patent Application No. 10-2024-0197576 filed on Dec. 26, 2024, with the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-shaped capacitor mounted on the printed circuit boards of various types of electronic products such as video display devices including Liquid Crystal Displays (LCD) and Plasma Display Panel (PDP), computers, smartphones and mobile phones, and the circuits of the onboard charger (OBC) DC-DC converter of electric vehicles, and the like, and playing a role in charging or discharging electricity.

In addition to the two-terminal MLCC having two external electrodes, three-terminal or four-terminal MLCCs with altered structures of internal and external electrodes have been developed to improve frequency characteristics.

An MLCC of the three-terminal type has a structure in which a signal internal electrode and a ground internal electrode are alternately stacked, and since the ground internal electrode pattern should be drawn out in a different direction from that of the signal internal electrode pattern, an area in which the internal electrode pattern formed on the dielectric layer during a stacking and compression process of a stack body may be wider than that of the MLCC of the two-terminal type, and an occurrence of a step portion therefrom may also be more severe than that of the MLCC of the two-terminal type.

On the other hand, the step portion generated during the stacking and compression process to form a body of the MLCC may cause stress imbalance in the body, which may reduce the mechanical strength of the MLCC, and may cause the internal electrode to be bent and the density of the dielectric layer to decrease, which may lower the reliability of the MLCC.

Accordingly, there is a need for structural improvement of the MLCC that may alleviate the step portion generated by a region in which the internal electrode is not formed in the MLCC having a three-terminal type.

### SUMMARY

An aspect of the present disclosure is to alleviate a difference between step portions occurring in a three-terminal MLCC.

An aspect of the present disclosure is to prevent delamination occurring in a three-terminal MLCC.

However, the aspects of the present disclosure are not limited to the above-described contents, and may be more easily understood in the process of describing specific example embodiments of the present disclosure.

A multilayer electronic component according to an example embodiment of the present disclosure may include: a body including a dielectric layer, a first internal electrode and a second internal electrode alternately disposed in a first direction with the dielectric layer interposed therebetween, a first surface and a second surface opposing each other in the first direction, a third surface and a fourth surface opposing each other in a second direction, perpendicular to the first direction, and a fifth surface and a sixth surface opposing each other in a third direction, perpendicular to the first direction and the second direction, a first dummy electrode spaced apart from the first internal electrode and connected to the fifth surface or the sixth surface, and a second dummy electrode spaced apart from the second internal electrode and connected to the third surface or the fourth surface; a first external electrode disposed on the third surface and connected to the first internal electrode; a second external electrode disposed on the fourth surface and connected to the first internal electrode; a third external electrode disposed on the fifth surface and connected to the second internal electrode; and a fourth external electrode disposed on the sixth surface and connected to the second internal electrode, and the first internal electrode may include a first main portion overlapping the second internal electrode in the first direction, and a first lead portion extending from the first main portion in the second direction, the second internal electrode may include a second main portion overlapping the first internal electrode in the first direction, and a second lead portion extending from the second main portion in the third direction, and the first main portion may include a first concave portion having a concave shape from a second direction center in the third direction, and the second main portion may include a second concave portion having a concave shape from a second direction center in the third direction.

One effect of the present disclosure is to improve an overlapping region of a first internal electrode and a second internal electrode in a first direction to reduce a step portion of a multilayer electronic component, by including a concave portion having a concave shape in a main portion in which the first internal electrode and the second internal electrode overlap each other in the first direction.

One effect of the present disclosure is to adjust relative positions between a first internal electrode, a second internal electrode, a first dummy electrode and a second dummy electrode to reduce a step portion of the multilayer electronic component and suppress an occurrence of delamination due to reduced adhesive strength between the dielectric layers.

However, the various advantageous advantages and effects of the present disclosure are not limited to the above-described contents, and may be more easily understood in the process of explaining specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic perspective view of a body according to an example embodiment;

FIG. 3 is a plan view schematically illustrating a form in which internal electrodes, dummy electrodes and dielectric patterns are disposed according to an example embodiment;

FIG. 4 is a schematic cross-sectional view of a multilayer electronic component according to an example embodiment taken along line A-A′ of FIG. 3;

FIG. 5 is a schematic cross-sectional view of a multilayer electronic component according to an example embodiment taken along line B-B′ of FIG. 3;

FIG. 6 is a schematic cross-sectional view of a multilayer electronic component according to an example embodiment taken along line C-C′ of FIG. 3;

FIG. 7 is a schematic cross-sectional view of a multilayer electronic component according to an example embodiment taken along line D-D′ of FIG. 3; and

FIG. 8 is a plan view schematically illustrating components of internal electrodes, dummy electrodes, and dielectric patterns according to an example embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to more completely explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawings, an X-direction may be defined as a direction in which first and second internal electrodes are alternately disposed with the dielectric layer interposed therebetween, or a first direction, and among a Y-direction and a Z-direction, which are directions, perpendicular to the X-direction, the Y-direction may be defined as a second direction, and the Z-direction may be defined as the third direction.

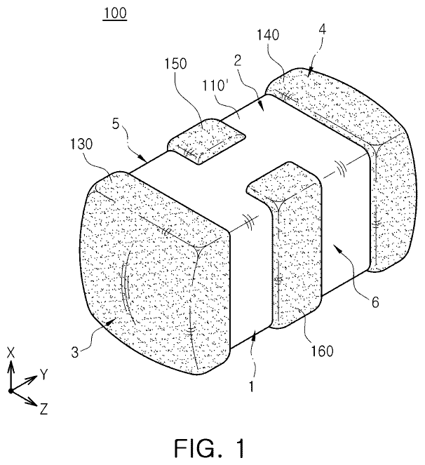

FIG. 1 is a schematic perspective view of a multilayer electronic component according to an example embodiment of the present disclosure;

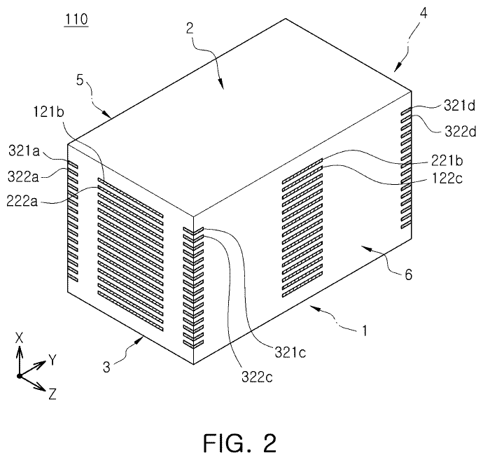

FIG. 2 is a schematic perspective view of a body according to an example embodiment;

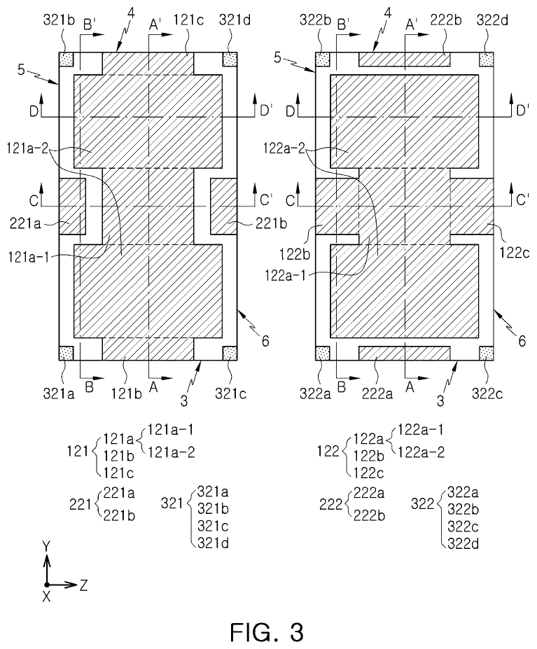

FIG. 3 is a plan view schematically illustrating a form in which internal electrodes, dummy electrodes and dielectric patterns are disposed according to an example embodiment;

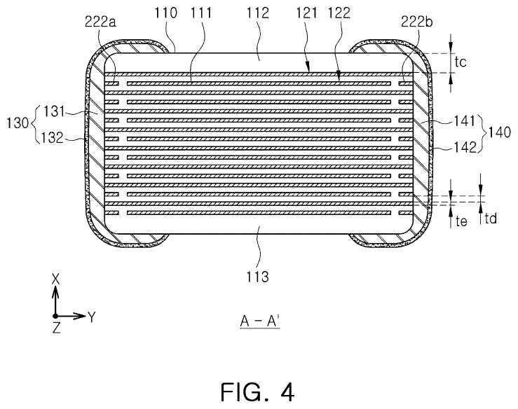

FIG. 4 is a schematic cross-sectional view of a multilayer electronic component according to an example embodiment taken along line A-A′ of FIG. 3;

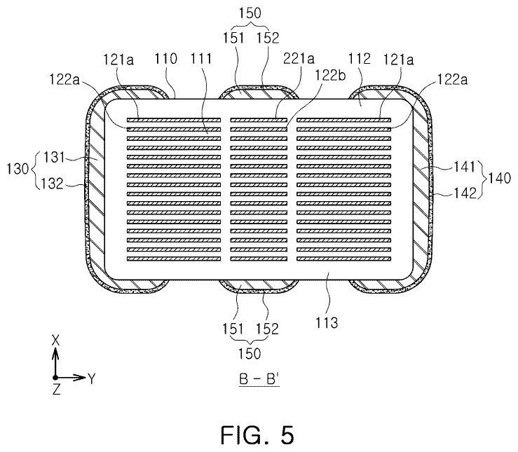

FIG. 5 is a schematic cross-sectional view of a multilayer electronic component according to an example embodiment taken along line B-B′ of FIG. 3;

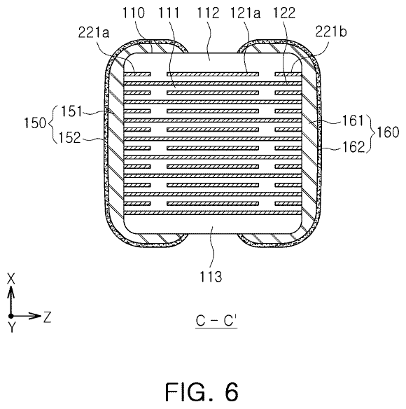

FIG. 6 is a schematic cross-sectional view of a multilayer electronic component according to an example embodiment taken along line C-C′ of FIG. 3;

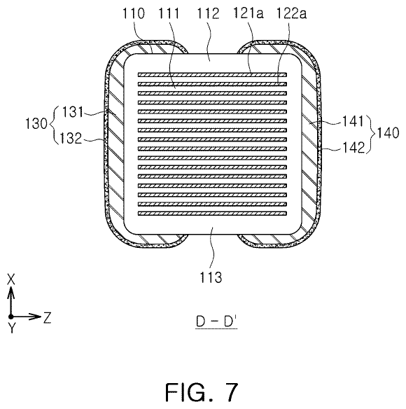

FIG. 7 is a schematic cross-sectional view of a multilayer electronic component according to an example embodiment taken along line D-D′ of FIG. 3; and

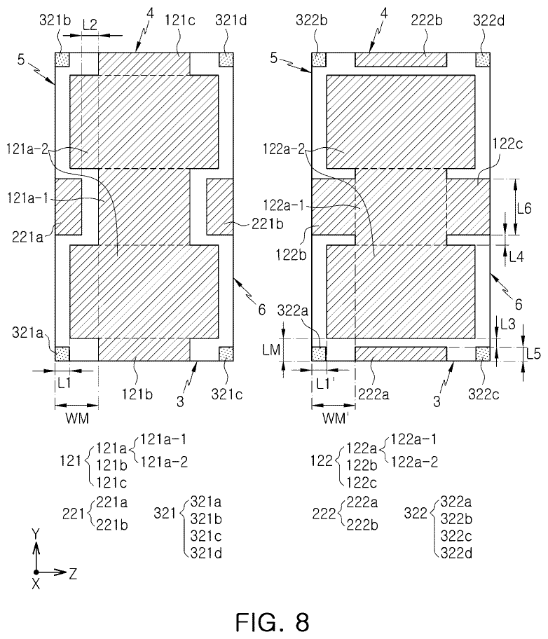

FIG. 8 is a plan view schematically illustrating components of internal electrodes, dummy electrodes, and dielectric patterns according to an example embodiment.

Hereinafter, with reference to FIGS. 1 to 8, a multilayer electronic component 100 according to an example embodiment of the present disclosure and various example embodiments thereof will be described in detail.

According to an example embodiment of the present disclosure, a multilayer electronic component 100 may include: a body 110 including a dielectric layer 111, a first internal electrode 121 and a second internal electrode 122 alternately disposed in a first direction with the dielectric layer 111 interposed therebetween, a first surface 1 and a second surface 2 opposing each other in the first direction, a third surface 3 and a fourth surface 4 opposing each other in a second direction, perpendicular to the first direction, a fifth surface 5 and a sixth surface 6 opposing each other in a third direction, perpendicular to the first and second directions, a first dummy electrode 221 spaced apart from the first internal electrode and connected to the fifth surface 5 or the sixth surface 6, a second dummy electrode 222 spaced apart from the second internal electrode 122 and connected to the third surface 3 or the fourth surface 4; a first external electrode 130 disposed on the third surface 3 and connected to the first internal electrode 121; a second external electrode 140 disposed on the fourth surface 4 and connected to the first internal electrode 121; a third external electrode 150 disposed on the fifth surface 4 and connected to the second internal electrode 122; and a fourth external electrode 160 disposed on the sixth surface 6 and connected to the second internal electrode 122, and the first internal electrode 121 may include a first main portion 121a overlapping the second internal electrode 122 in the first direction and first lead portions 121b and 121c disposed to extend from the first main portion 121a in the second direction, the second internal electrode 122 may include a second main portion 122a overlapping the first internal electrode 121 in the first direction and second lead portions 122b and 122c disposed to extend from the second main portion 122a in the third direction, and the first main portion 121a may include a concave portion 121a-1 having a concave shape from a second direction center in the third direction, and the second main portion 122a may include a concave portion 122a-1 having a concave shape from the second direction center in the third direction.

The body 110 may include the dielectric layer 111, the first internal electrode 121, the second internal electrode 122, the first dummy electrode 221, the second dummy electrode 222, and the first surface 1 to the sixth surface 6.

The dielectric layer 111 and the first and second internal electrodes 121 and 122 may be alternately disposed within the body 110, and a direction in which the internal electrodes 121 and 122 and the body 110 are alternately arranged may be defined as a stacking direction or a first direction.

There is no particular limitation on the specific shape of the body 110, but as illustrated in FIG. 2, the body 110 may be formed into a hexahedron or a similar shape. Additionally, the shape of the body 110 may not be a hexahedron having perfectly straight edges due to shrinkage in a sintering process, or through a separate polishing process, but may substantially have a hexahedron shape.

Referring to FIG. 2, the body 110 may have the first surface 1 and the second surface 2 opposing each other in a first direction, the third surface 3 and the fourth surface 4 opposing each other in the second direction, perpendicular to the first direction, and the fifth surface 5 and the sixth surface 6 opposing each other in a third direction, perpendicular to the first and second directions.

A plurality of dielectric layers 111 forming the body 110 are in a sintered state, and the boundaries between the dielectric layers 111 adjacent to each other may be integrated so as to be difficult to identify without using a scanning electron microscope (SEM).

A main component of the dielectric composition forming the dielectric layer 111 is not particularly limited as long as sufficient electrostatic capacity may be obtained. For example, the dielectric layer 111 may include a perovskite-type compound represented by ABO₃ as a main component. The perovskite compound represented by ABO₃ may include, for example, one or more of BaTiO₃, (Ba1-ₓCaₓ)TiO₃ (0<x<1), Ba (Ti1-_{y}Ca_{y})O₃ (0<y<1), (Ba1-ₓCaₓ) (Ti1-_{y}Zr_{y})O₃ (0<x<1, 0<y<1), Ba(Ti1-_{y}Zr_{y})O₃ (0<y<1), CaZrO₃, and (Ca1-ₓSrₓ)(Zr1-_{y}Ti_{y})O₃ (0<x≤0.5, 0<y≤0.5).

Referring to FIGS. 4 to 7, cover portions 112 and 113 may be disposed in a region from an external electrode disposed on an outermost layer of the first and second internal electrodes 121 and 122 to the first surface 1 or the second surface 3 of the body 110.

The cover portions 112 and 113 may be formed by stacking a single dielectric layer or two or more dielectric layers on upper and lower surfaces of a stack body in which the first and second internal electrodes 121 and 122 and the dielectric layer 111 are stacked in a thickness direction, respectively, and may basically play a role in preventing damage to the internal electrode due to physical or chemical stress.

The cover portions 112 and 113 do not include the first and second internal electrodes 121, the first and second dummy electrodes 221 and 222, and the dielectric patterns 321 and 322, and may include the same material as the dielectric layer 111. That is, the cover portions 112 and 113 may include a ceramic material, and may, for example, include the same ceramic material as the dielectric layer 111.

An average thickness tc of the cover portions 112 and 113 does not need to be specifically limited. However, in order to more easily achieve miniaturization and high capacity of the multilayer electronic component, the average thickness tc of the cover portions 112 and 113 may be 15 μm or less.

The average thickness tc of the cover portions 112 and 113 may refer to a first direction size, and may be an average value of the first direction size of the cover portions 112 and 113 measured at five points spaced apart from each other by equal intervals in an upper portion or a lower portion of the capacitance formation portion Ac.

The internal electrodes 121 and 122 may be included in the body 110 together with the dielectric layer 111, and may include a first internal electrode 121 and a second internal electrode 122.

The first internal electrode 121 may be connected to the third surface 3 and the fourth surface 4, and may be connected to the first external electrode 130 and the second external electrode 140 described below through the third surface 3 and the fourth surface 4. Meanwhile, the first internal electrode 121 may be spaced apart from the fifth surface 5 and the sixth surface 6.

Referring to FIG. 3, the first internal electrode 121 may include a first main portion 121a overlapping the second internal electrode 122 in the first direction, and first lead portions 121b and 121c extending from the first main portion 121a in the second direction.

The first lead portions 121b and 121c may include a first-first lead portion 121b in which an end thereof is in direct contact with the first external electrode 130 and a first-second lead portion 121c in which an end thereof is in direct contact with the second external electrode 140.

The second internal electrode 122 may be connected to the fifth surface 5 and the sixth surface 6, and may be connected to the third external electrode 150 and the fourth external electrode 160 described below through the fifth surface 5 and the sixth surface 6. Meanwhile, the second internal electrode 122 may be spaced apart from the third surface 3 and the fourth surface 4.

Referring to FIG. 3, the second internal electrode 122 may include a second main portion 122a overlapping the first internal electrode 121 in the first direction, and second lead portions 122b and 122c extending from the second main portion 122a in the third direction.

The second lead portions 122b and 122c may include a second-first lead portion 122b in which an end thereof is in direct contact with the fifth surface 5 and a second-second lead portion 122c in which an end thereof is in direct contact with the sixth surface 6.

The internal electrode 121 and the second internal electrode 122 may be electrically separated by a dielectric layer 111 disposed therebetween, and may be electrically separated from the external electrode that is not connected through a space separated from a surface of the body 110.

The material including the internal electrode 121 and 122 is not particularly limited, and a material having excellent electrical conductivity may be used. For example, the internal electrode 121 and 122 may include one or more of nickel (Ni), copper (Cu), palladium (Pd), silver (Ag), gold (Au), platinum (Pt), tin (Sn), tungsten (W), titanium (Ti) and alloys thereof.

The body 110 may include first dummy electrodes 221a and 221b spaced apart from the first internal electrode 121 and connected to the fifth surface 5 or the sixth surface 6, and may include second dummy electrodes 222a and 222b spaced apart from the second internal electrode 122 and connected to the third surface 3 or the fourth surface 4.

Referring to FIG. 3, the first dummy electrodes 221a and 221b may include a first-first dummy electrode 221a in which an end thereof is in contact with the fifth surface 5 and a first-second dummy electrode 221b in which an end thereof is in contact with the sixth surface 6, and the second dummy electrodes 222a and 222b may include a second-first dummy electrode 222a in which an end thereof is in contact with the third surface 3 and a second-second dummy electrode 222b in which an end thereof is in contact with the fourth surface 4.

The first and second dummy electrodes 221a and 221b may be disposed on dielectric layers in which the first and second internal electrodes 121 and 122 are not disposed, respectively, and thus may play a role in alleviating a step portion of the multilayer electronic component.

The material included in the first and second dummy electrodes 221a and 221b is not particularly limited, and the same material as the first and second internal electrodes 121 and 122 may be used. For example, the first and second dummy electrodes 221a and 221b may include one or more of nickel (Ni), copper (Cu), palladium (Pd), silver (Ag), gold (Au), platinum (Pt), tin (Sn), tungsten (W), titanium (Ti) and alloys thereof.

Meanwhile, a step portion occurring during the stacking and pressing process for forming the body of the MLCC may cause stress imbalance in the body, which may reduce the mechanical strength of the MLCC, and may cause the reliability of the MLCC to decrease, such as bending the internal electrode and reducing the density of the dielectric layer.

Meanwhile, the step portion may be more severe in the case of a three-terminal MLCC due to the structural and morphological differences between the signal internal electrode and the ground internal electrode.

Specifically, in the case of a three-terminal MLCC, since withdrawing portions of the signal internal electrode and the ground internal electrode are formed in different directions, so that a region in which the signal internal electrode and the ground internal electrode overlap each other in the first direction may not be sufficient as compared to an internal electrode structure of a two-terminal MLCC, and as a result, a region in which the internal electrode is not formed on the dielectric layer may increase as compared to the two-terminal MLCC structure.

As a method of alleviating the step portion in the 3-terminal MLCC structure, a method of printing a step alleviating pattern on the dielectric layer on which the signal internal electrode or the ground internal electrode is not formed may be considered. Forming a separate step alleviating pattern requires a separate additional process to cause a material transfer to an adjacent dielectric layer during a sintering process, which may have a negative effect on the characteristics of the dielectric layer.

Accordingly, in an example embodiment of the present disclosure, the first main portion 121a of the first internal electrode 121 may include a first concave portion 121a-1 having a concave shape from a second direction center in the third direction, and the second main portion 122a of the second internal electrode 122 may include a second concave portion 122a-1 having a concave shape from the second direction center in the third direction, thereby sufficiently securing an overlapping region of the first internal electrode 121 and the second internal electrode 122 in the first direction as well as effectively alleviating the step portion of the multilayer electronic component 100 without an additional process.

In this case, the center of the first internal electrode 121 in the second direction may refer to a region disposed in a center, among three equal parts into which the first main portion 121a are divided in the second direction, and a center of the second internal electrode 122 in the second direction may refer to a region disposed in a center, among three equal parts into which the second main portion 122a is divided in the second direction. That is, in an example embodiment, the first concave portion 121a-1 may be disposed in a region disposed in a center, among the three equal parts into which the first main portion 121a is divided in the second direction, and the second concave portion 122a-1 may be disposed in a region disposed in a center, among the three equal parts into which the second main portion 122a is divided in the second direction.

A method of forming first dummy patterns 221a and 221b and second dummy patterns 222a and 222b is not particularly limited. For example, the first dummy patterns 221a and 221b may be formed by cutting off a portion of the second internal electrode 122, and the second dummy patterns 222a and 222b may be formed by cutting off a portion of the first internal electrode 121. The first and second dummy patterns 221a, 221b, 222a and 222b may be disposed on the dielectric layer 111 on which the first and second internal electrodes 121 and 122 are not formed, respectively, thereby performing the effect of alleviating the step portion, and since no additional printing process is performed other than a process of printing the internal electrodes 121 and 122, the efficiency of the process may be improved.

In an example embodiment, the second lead portions 122b and 122c are disposed to extend in the third direction from the second concave portion 122a-1, and an average length of the second lead portions 122b and 122c in the second direction may be shorter than an average length of the second concave portion in the second direction. Accordingly, not only may an exposed area of the lead portions 122b and 122c into which external moisture may penetrate be minimized, but also, by forming the first dummy electrodes 221a and 221b in the margin portion adjacent to the first concave portion 121a-1, the step portion of the multilayer electronic component 100 may be alleviated. In this case, a difference between the average length of the second lead portions 122b and 122c in the second direction and the average length of the second concave portion in the second direction may be 10 μm or more, but is not limited thereto and may vary depending on the size of the multilayer electronic component.

In an example embodiment, at least a portion of the first dummy electrodes 221a and 221b may overlap the second lead portions 122b and 122c in the first direction. A structure in which at least a portion of the first dummy electrodes 221a and 221b overlaps the second lead portions 122b and 122c in the first direction may be formed by adjusting shapes of a pattern for forming the first internal electrode 121 and a pattern for forming the second internal electrode 122, and accordingly, the effect of alleviating the step portion of the multilayer electronic component 100 may be further improved.

Similarly, in an example embodiment, at least a portion of the second dummy electrodes 222a and 222b may overlap first lead portions 121b and 121c in the first direction.

Referring to FIGS. 2 and 3, the body 110 may include dielectric patterns 321 and 322 in contact with a corner in which the third surface 3 and the fifth surface 5 meet, a corner in which the fourth surface 4 and the fifth surface 5 meet, a corner in which the third surface 3 and the sixth surface 6 meet, and a corner in which the fourth surface 4 and the sixth surface 4 meet.

The dielectric patterns 321 and 322 may be disposed on each dielectric layer 111 in which the first and second internal electrodes 121 and 122 are formed, and may be disposed at a corner of the body 110 in which plastic shrinkage is severe, thereby alleviating the step portion of the multilayer electronic component 100 and alleviating the occurrence of delamination.

The dielectric patterns 321 and 322 may include the same material as the dielectric layer 111, but may further include a dye to be distinguishable from the dielectric layer 111 and to identify cracks that may occur at the corners of the body 110.

The dye included in the dielectric patterns 321 and 322 is not particularly limited, and the dielectric patterns 321 and 322 may include one or more of inorganic dyes such as iron oxide (Fe₂O₃), manganese oxide (MnO₂), ceramic dyes such as zirconium oxide (ZrO₂), cobalt oxide (Co₃O₄), and mixtures thereof. Since the dielectric patterns 321 and 322 includes one or more of these inorganic dyes, ceramic dyes, and mixtures thereof, it may be possible to identify cracks that may occur at the corners of the body 110 even after sintering.

Referring to FIG. 3, the dielectric patterns 321 and 322 may be distinguished from each other depending on the position in which the dielectric patterns 321 and 322 are disposed. Specifically, the dielectric pattern disposed on the same dielectric layer as the first internal electrode 121 may be distinguished as the first dielectric pattern 321, and the dielectric pattern disposed on the same dielectric layer as the second internal electrode 122 may be distinguished as the second dielectric pattern 322.

The first dielectric pattern 321 may include a first-first dielectric pattern 321a in contact with the third surface 3 and the fifth surface 5, a first-second dielectric pattern 321b in contact with the fourth surface 4 and the fifth surface 5, a first-third dielectric pattern 321c contacting the third surface 3 and the sixth surface 6, and a first-fourth dielectric pattern 321d in contact with the fourth surface 4 and the sixth surface 6.

The second dielectric pattern 322 may include a second-first dielectric pattern 322a in contact with the third surface 3 and the fifth surface 5, a second-second dielectric pattern 322b in contact with the fourth surface 4 and the fifth surface 5, a second-third dielectric pattern 322c in contact with the third surface 3 and the sixth surface 6, and a second-fourth dielectric pattern 322d in contact with the fourth surface 4 and the sixth surface 6.

Referring to FIG. 4, the first internal electrode 121 and the second internal electrode 122 may overlap each other in the first direction, and the second dummy electrodes 222a and 222b may be connected to the first external electrode 130 or the second external electrode 140 and may be to be spaced apart from the second internal electrode 122.

Referring to FIG. 5, the first dummy electrodes 221a and 221b may be spaced apart from the first main portion 121a and may overlap the second lead portion 122b in the first direction. In FIG. 5, the first main portion 121a and the second main portion 122a may be spaced apart from the first external electrode 130 and the second external electrode 140, but the first internal electrode 121 may be connected to the first and second external electrodes 130 and 140 through the first lead portions 121b and 121c, and the second internal electrode 122 may be connected to the third and fourth external electrodes 150 and 160 through the second lead portions 122b and 122c.

Referring to FIG. 6, the first main portion 121a is a region overlapping the second internal electrode 122 in the first direction, and the first dummy electrodes 221a and 221b may be spaced apart from the first main portion 121a. Meanwhile, the first dummy electrodes 221a and 221b and the second internal electrode 122 may overlap each other in the first direction.

Referring to FIG. 7, the first main portion 121a and the second main portion 122a may overlap each other in the first direction, and an overlapping area of the first main portion 121a and the second main portion 122a in the first direction may be wider than an overlapping area of the first dummy electrodes 221a and 221b and the second internal electrode 122 of FIG. 6.

Referring to FIG. 8, a separation distance between the first lead portions 121b and 121c and the fifth surface 5 or the sixth surface 6 in the third direction is indicated as WM, and a separation distance between the first main portion 121a and the fifth surface 5 or the sixth surface 6 in the third direction is indicated as L1.

In an example embodiment, L1 may be 10 μm or more, and L1/WM may be 0.1 or less. Accordingly, the effect of alleviating the step portion of the multilayer electronic component 100 may be improved, and the occurrence of delamination due to the decrease in the adhesive strength between the dielectric layers may be alleviated. When L1 is less than 10 μm, the effect of alleviating the step portion may be insufficient, and when L1/WM exceeds 0.1, delamination may occur due to the decrease in the adhesive strength between the dielectric layers.

Referring to FIG. 8, a separation distance between the second dummy electrodes 222a and 222b and the fifth surface 5 or the sixth surface 6 in the third direction is indicated as WM, and a separation distance between the second main portion 122a and the fifth surface 5 or the sixth surface 6 in the third direction is indicated as L1′.

In an example embodiment, L1′ may be 10 μm or more, and L1′/WM′ may be 0.1 or less. Accordingly, the effect of alleviating the step portion of the multilayer electronic component 100 may be improved, and the occurrence of delamination due to the decrease in the adhesive strength between the dielectric layers may be alleviated. When L1′ is less than 10 μm, the effect of alleviating the step portion may be insufficient, and when L1′/WM′ exceeds 0.1, delamination may occur due to the decrease in the adhesive strength between the dielectric layers.

Referring to FIG. 8, a separation distance between the first concave portion 121a-1 and the first dummy electrodes 221a and 221b in the third direction is indicated as L2.

In an example embodiment, L2 may be 10 μm or more, and L2/WM may be 0.2 or less. Accordingly, the effect of alleviating the step portion of the multilayer electronic component 100 may be improved, and the occurrence of short circuiting between the internal electrode and the dummy electrode may be prevented. When L2 is less than 10 μm, the effect of alleviating the step portion may be insufficient, and when L2/WM exceeds 0.2, a gap between the internal electrode and the dummy electrode may be narrow, which may cause the short circuiting to occur.

Referring to FIG. 8, a separation distance between the second internal electrode 122 and the second dummy electrodes 222a and 222b in the second direction is indicated as L3, and a separation distance between the second internal electrode 122 and the third surface 3 or the fourth surface 4 in the second direction is indicated as LM.

In an example embodiment, L3/LM may be 0.05 or more and 0.3 or less. Accordingly, the effect of alleviating the step portion of the multilayer electronic component 100 may be sufficiently secured, and a short circuit between the internal electrode and the dummy electrode may be prevented. When L3/LM is less than 0.05, a short circuit between the internal electrode and the dummy electrode may occur, and when L3/LM exceeds 0.3, the effect of alleviating the step portion may be insufficient.

Referring to FIG. 8, the first main portion 121a may include a first convex portion 121a-2 which is a region disposed on both sides of the first concave portion 121a-1 in the second direction, and the second main portion 122a may include a second convex portion 122a-2 which is a region disposed on both sides of the second concave portion 122a-1 in the second direction.

In FIG. 8, a separation distance between the second lead portions 122b and 122c and the second convex portion 122a-2 in the second direction is indicated as L4.

In an example embodiment, L4 may be 10 μm or more, and accordingly, pattern overlapping of the main portion 122a and the lead portions 122b and 122c of the second internal electrode 122 may be prevented. An upper limit value of LA is not particularly limited and may vary depending on the size of the multilayer electronic component 100.

In FIG. 8, an average length of the second dummy electrodes 222a and 222b in the second direction is indicated as L5.

In an example embodiment, L5 may be 5 μm or more, and accordingly, delamination caused by decreased adhesion between dielectric layers may be alleviated, and short circuiting between the dummy electrode and the internal electrode may be prevented. An upper limit value of L5 is not particularly limited and may vary depending on the size of the LM.

In FIG. 8, an average length of the third direction of the second lead portions 122b and 122c is indicated as L6.

In an example embodiment, L6 may be 5 μm or more, thereby alleviating delamination caused by reduced adhesion between dielectric layers, and preventing short circuiting between the dummy electrode and the internal electrode. An upper limit value of L6 is not particularly limited and may vary depending on the size of the LM.

An example of a method of measuring L1 to L6, L1′, WM, WM′ and LM may include a method of measuring the second and third direction cross-sections of the multilayer electronic component 100 using a measuring device such as an optical microscope (OM) or a scanning electron microscope (SEM). When measuring separation distances among L1 to L6, L1′, WM, WM′, LM, a minimum value of the separation distance may be measured, and when specifying an average length or an average width, an average value of the values measured at three or more points spaced apart from each other by equal intervals in a direction, perpendicular to the length or width, may be measured.

Referring to FIG. 1, external electrodes 130, 140, 150 and 160 may be disposed on the body 110.

Referring to FIG. 3 and FIG. 4, the external electrodes 130, 140, 150 and 160 may include a first external electrode 130 disposed on the third surface 3 of the body 110 and connected to the first internal electrode 121, a second external electrode 140 disposed on the fourth surface 4 and connected to the first internal electrode 121, a third external electrode 150 disposed on the fifth surface 5 and connected to the second internal electrode 122, and a fourth external electrode 160 disposed on the sixth surface 6 and connected to the second internal electrode 122.

Meanwhile, the external electrodes 130, 140, 150 and 160 may be formed using any material that has electrical conductivity, such as metal, and a specific material may be determined by considering electrical characteristics, structural stability, and the like, and further, can have a multilayer structure.

For example, the external electrodes 130, 140, 150 and 160 may include electrode layers 131, 141, 151 and 161 disposed on the body 110 and plating layers 132, 142, 152 and 162 formed on the electrode layers 131, 141, 151 and 161.

For a more specific example of the electrode layers 131, 141, 151 and 161, the electrode layer may be a sintered electrode including a conductive metal and glass, or a resin-based electrode including a conductive metal and resin.

Additionally, the electrode layers 131, 141, 151 and 161 may be formed in a form in which a sintered electrode and a resin electrode are sequentially formed on the body. Additionally, the electrode layers may be formed by transferring a sheet including a conductive metal onto the body, or may be formed by transferring a sheet including a conductive metal onto the sintered electrode.

A material having excellent electrical conductivity may be used as the conductive metal included in the electrode layers 131, 141, 151 and 161, and is not particularly limited. For example, the conductive metal may be at least one of nickel (Ni), copper (Cu), and alloys thereof, and may preferably be copper (Cu) to improve adhesion with the body.

The plating layers 132, 142, 152 and 162 may serve to improve the mounting characteristics. The type of the plating layers 132, 142, 152 and 162 is not particularly limited, and may be a plating layer including at least one of Ni, Sn, Pd, and alloys thereof, and may be formed of a plurality of layers.

For a more specific example of the plating layers 132, 142, 152 and 162, the plating layer may be a Ni plating layer or an Sn plating layer, and may be in a form in which the Ni plating layer and the Sn plating layer are sequentially formed on the electrode layers 131, 141, 151 and 161, and may be in a form in which the Sn plating layer, the Ni plating layer, and the Sn plating layer are sequentially formed. Additionally, the plating layer may include a plurality of Ni plating layers and/or a plurality of Sn plating layers.

### (Inventive Example)

Table 1 shows the results of evaluating whether cracks or delamination occur after sintering in samples with different L1/WM, and printability and DC resistance are suitable.

A sample size is 1005 Size, and the number of internal electrode layers is 450 to 500.

For each test number, a total of 63 lots were tested, and 35 samples were randomly extracted from each lot to evaluate each characteristic.

Test No. 1 is a case in which the first internal electrode and the second internal electrode do not include a concave portion like the present disclosure, and Test No. 2 to 6 are cases in which, like an example embodiment of the present disclosure, a first dummy electrode 221 spaced apart from a first internal electrode and connected to a fifth surface 5 or the sixth surface 6 and a second dummy electrode 222 spaced apart from a second internal electrode 122 and connected to a third surface 3 or a fourth surface 4, are included, and a first main portion 121a of the first internal electrode 121 includes a first concave portion 121a-1 having a concave shape from the second direction center in the third direction, and a second main portion 122a of the second internal electrode 122 includes a second concave portion 122a-1 having a concave shape from the second direction center in the third direction.

The crack and delamination defect ratio was evaluated by observing the WT and LT cross-sections with an optical microscope to determine whether cracks or delamination occurred. When the crack or delamination rate was 10% or more, this was evaluated as Δ, and when the crack or delamination rate was less than 5%, this was evaluated as ⊚.

The printability evaluation was evaluated as A when the dummy electrode overlapped the internal electrode, or when the dummy electrode or internal electrode was exposed to a surface of an unintended body in 10% or more, and the printability evaluation was evaluated as ⊚ when the same situations occurred in less than 5%.

The DC resistance evaluation was performed by measuring the DC insulation resistance of a plurality of samples using a DC resistance measuring device that may test a plurality of samples simultaneously, and when a ratio of a decrease value of the DC insulation resistance as compared to an initial DC insulation resistance was 0.7% or more, this was evaluated as Δ, when the ratio was 0.5% or more but less than 0.7%, this was evaluated as ◯, and when the ratio was less than 0.5%, this was evaluated as ⊚.

TABLE 1

| | | | | | Compre- |
|---|---|---|---|---|---|
| | | Crack/ | | | hensive |
| Test | | Delamination | print- | DC | Determi- |
| Number | L1/WM | Defect Ratio | ability | resistance | nation |
| 1 | — | 56% | — | — | — |
| 2 | 0.4 | 44% | ⊚ | Δ | Δ |
| 3 | 0.3 | 37% | ⊚ | Δ | Δ |
| 4 | 0.2 | 29% | ⊚ | ◯ | Δ |
| 5 | 0.1 | 19% | ⊚ | ◯ | ⊚ |
| 6 | 0.05 | 11% | Δ | ⊚ | ⊚ |

Referring to Table 1, it may be confirmed that the crack and delamination defect ratio increases as L1/WM increases, and it may be confirmed that when L1/WM exceeds 0.1, defects exceeding 19% occur, and the DC resistance characteristics deteriorate as the defect rate increases. Accordingly, as in an example embodiment, by satisfying L1/WM to be 0.1 or less, the step portion of the multilayer electronic component may be alleviated, and the problem of cracks and delamination may be alleviated.

Meanwhile, L1/WM may preferably exceed 0.05, and thus, overlapping between electrodes may be prevented during electrode printing.

Meanwhile, the results of Table 1 may be applied to L1′/WM as well. That is, when L1′/WM′ is 0.1 or less, the step portion of the multilayer electronic component may be alleviated, and the problem of cracks and delamination may be alleviated.

Although an example embodiment of the present disclosure has been described in detail above, the present disclosure is not limited to the above-described embodiments and the accompanying drawings but is defined by the appended claims.

Therefore, those of ordinary skill in the art may make various replacements, modifications, or changes without departing from the technical concept of the present disclosure defined by the appended claims, and these replacements, modifications, or changes should be construed as being included in the technical concept of the present disclosure.

Additionally, the expression ‘an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific example embodiment are not described in another example embodiment, the items may be understood as a description related to another example embodiment unless a description opposite or contradictory to the items is in another example embodiment.

In the present disclosure, the terms are merely used to describe a specific example embodiment, and are not intended to limit the present disclosure. Singular forms may include plural forms as well unless the context clearly indicates otherwise.

What is claimed is:

1. A multilayer electronic component, comprising:
a body including a dielectric layer, a first internal electrode and a second internal electrode alternately disposed in a first direction with the dielectric layer interposed therebetween, a first surface and a second surface opposing each other in the first direction, a third surface and a fourth surface opposing each other in a second direction, perpendicular to the first direction, and a fifth surface and a sixth surface opposing each other in a third direction, perpendicular to the first direction and the second direction, a first dummy electrode spaced apart from the first internal electrode and connected to the fifth surface or the sixth surface, and a second dummy electrode arranged to be spaced apart from the second internal electrode and connected to the third surface or the fourth surface;
a first external electrode disposed on the third surface and connected to the first internal electrode;
a second external electrode disposed on the fourth surface and connected to the first internal electrode;
a third external electrode disposed on the fifth surface and connected to the second internal electrode; and
a fourth external electrode disposed on the sixth surface and connected to the second internal electrode,
wherein the first internal electrode includes a first main portion overlapping the second internal electrode in the first direction, and a first lead portion extending from the first main portion in the second direction,
the second internal electrode includes a second main portion overlapping the first internal electrode in the first direction, and a second lead portion extending from the second main portion in the third direction, and
the first main portion includes a first concave portion having a concave shape from a second direction center in the third direction, and the second main portion includes a second concave portion having a concave shape from a second direction center in the third direction.

2. The multilayer electronic component according to claim 1, wherein the second lead portion is disposed to extend from the second concave portion in the third direction, and
an average length of the second lead portion in the second direction is shorter than an average length of the second concave portion in the second direction.

3. The multilayer electronic component according to claim 2, wherein a difference between the average length of the second lead portion in the second direction and the average length of the second concave portion in the second direction is 10 μm or more.

4. The multilayer electronic component according to claim 1, wherein at least a portion of the first dummy electrode overlaps the second lead portion in the first direction.

5. The multilayer electronic component according to claim 1, wherein at least a portion of the second dummy electrode overlaps the first lead portion in the first direction.

6. The multilayer electronic component according to claim 1, wherein the first concave portion is disposed in a region disposed in a center, among three equal parts into which the first main portion is divided in the second direction, and
the second concave portion is disposed in a region disposed in a center, among three equal parts into which the second main portion is divided in the second direction.

7. The multilayer electronic component according to claim 1, wherein the body further includes a dielectric pattern in contact with a corner in which the third surface meets the fifth surface, a corner in which the fourth surface meets the fifth surface, a corner in which the third surface meets the sixth surface, and a corner in which the fourth surface meets the sixth surface.

8. The multilayer electronic component according to claim 1, wherein when a separation distance between the first lead portion and the fifth or sixth surface in the third direction is defined as WM, and when a separation distance between the first main portion and the fifth or sixth surface in the third direction is defined as L1, L1 is 10 μm or more, and L1/WM is 0.1 or less.

9. The multilayer electronic component according to claim 1, wherein when a separation distance between the second dummy electrode and the fifth or sixth surface in the third direction is defined as WM′, and when a separation distance between the second main portion and the fifth or sixth surface in the third direction is defined as L1′, L1′ is 10 μm or more, and L1′/WM′ is 0.1 or less.

10. The multilayer electronic component according to claim 1, wherein when a separation distance between the first lead portion and the fifth or sixth surface in the third direction is defined as WM, and when a separation distance between the first concave portion and the first dummy electrode in the third direction is defined as L2,
L2 is 10 μm or more, and L2/WM is 0.2 or less.

11. The multilayer electronic component according to claim 1, wherein when a separation distance between the second internal electrode and the second dummy electrode in the second direction is defined as L3, and when a separation distance between the second internal electrode and the third or fourth surface in the second direction is defined as LM, L3/LM is 0.05 or more and 0.3 or less.

12. The multilayer electronic component according to claim 1, wherein when a region disposed on both sides of the second concave portion of the second internal electrode in the second direction is defined as a second convex portion, and a separation distance by which the second lead portion is spaced apart from the second convex portion in the second direction is defined as L4,
L4 is 10 μm or more.

13. The multilayer electronic component according to claim 1, wherein when an average length of the second dummy electrode in the second direction is defined as L5,
L5 is 5 μm or more.

14. The multilayer electronic component according to claim 1, wherein when an average length of the second lead portion in the third direction is defined as L6,
L6 is 5 μm or more.
